(19) United States
(12) Patent Application Publication
(10) Pub. No.: US 2023/0177625 A1
(43) Pub. Date: Jun. 8, 2023

(54) SYSTEMS AND METHODS FOR COMPUTERIZED CONTRACT LIFECYCLE MANAGEMENT

(71) Applicant: Thaija Dickerson, Richmond, TX (US)

(72) Inventor: Thaija Dickerson, Richmond, TX (US)

(21) Appl. No.: 17/991,838

(22) Filed: Nov. 21, 2022

Related U.S. Application Data
(60) Provisional application No. 63/281,733, filed on Nov. 21, 2021.

(51) Int. Cl. G06Q 50/18; H04L 9/32

(52) U.S. Cl. CPC G06Q 50/18; H04L 9/3236

(57) ABSTRACT

Systems and methods for computerized contract formation and monitoring are described.

### RELATED APPLICATIONS

This application claims the benefit of U.S. Application No. 63/281,733, entitled “Systems and Methods for Computerized Contract Formation and Monitoring,” and filed on Nov. 21, 2021, which is incorporated herein by reference in its entirety.

### FIELD

Some implementations are generally related to contract formation and monitoring, and, in particular, to systems and methods for computerized contract formation and monitoring.

### BACKGROUND

Some conventional contract management systems may not provide complete contract lifecycle management and may not learn the practices of a given organization or individual practices and adapt over time. Some implementations were conceived in light of the above-mentioned limitations among other things.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a block diagram of an example web 2.0 architecture which may be used for one or more implementations described herein.

FIG. 3 is a block diagram of an example web 3.0 architecture which may be used for one or more implementations described herein.

FIG. 4 is a diagram showing a contract lifecycle management process in accordance with some implementations.

FIG. 5 is a diagram showing details of computerized automatic document processing in accordance with some implementations.

FIG. 6 is a diagram showing details of digital contract processing in accordance with some implementations.

FIG. 7 is a block diagram of an example computing device which may be used for one or more implementations described herein.

### DETAILED DESCRIPTION

Some implementations include computerized contract lifecycle methods and systems.

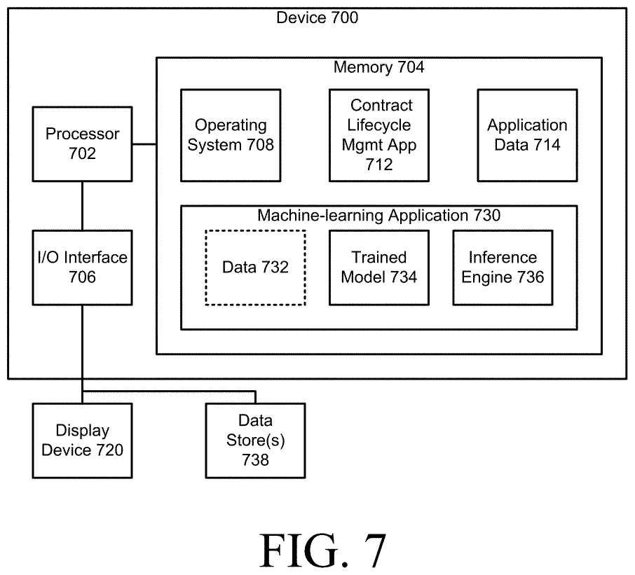

When performing computerized contract lifecycle management functions, it may be helpful for a system to suggest contract terms or negotiation playbook strategies and/or to make predictions about contract obligation fulfilment. To make predictions or suggestions, a probabilistic model (or other model as described below in conjunction with FIG. 7) can be used to make an inference (or prediction) about aspects of contract lifecycle such as negotiation and ongoing monitoring. Accordingly, it may be helpful to make an inference regarding a probability that a contract may be performed according to terms in the contract. Other aspects can be predicted or suggested as described below.

The inference based on the probabilistic model can include predicting contract performance and tracking in accordance with image (or other data) analysis and confidence score as inferred from the probabilistic model. The probabilistic model can be trained with data including previous contract negotiation and monitoring data. Some implementations can include generating negotiation suggestions based on previous contracts and organizational playbooks.

The systems and methods provided herein may overcome one or more deficiencies of some conventional contract monitoring systems and methods.

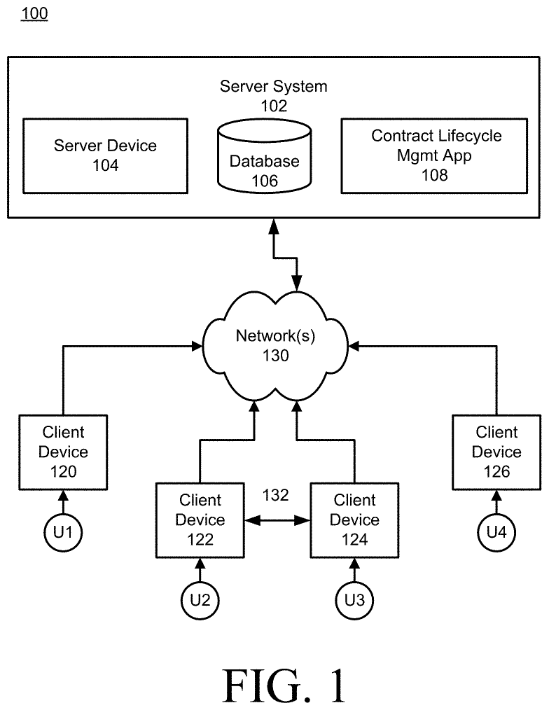

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform full life cycle contract formation, management, and monitoring functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide full life cycle contract formation, management, and monitoring functions as shown in the attached figures and described herein.

Various implementations of features described herein can use any type of system and/or service. Any type of electronic device can make use of features described herein. Some implementations can provide one or more features described herein on client or server devices disconnected from or intermittently connected to computer networks.

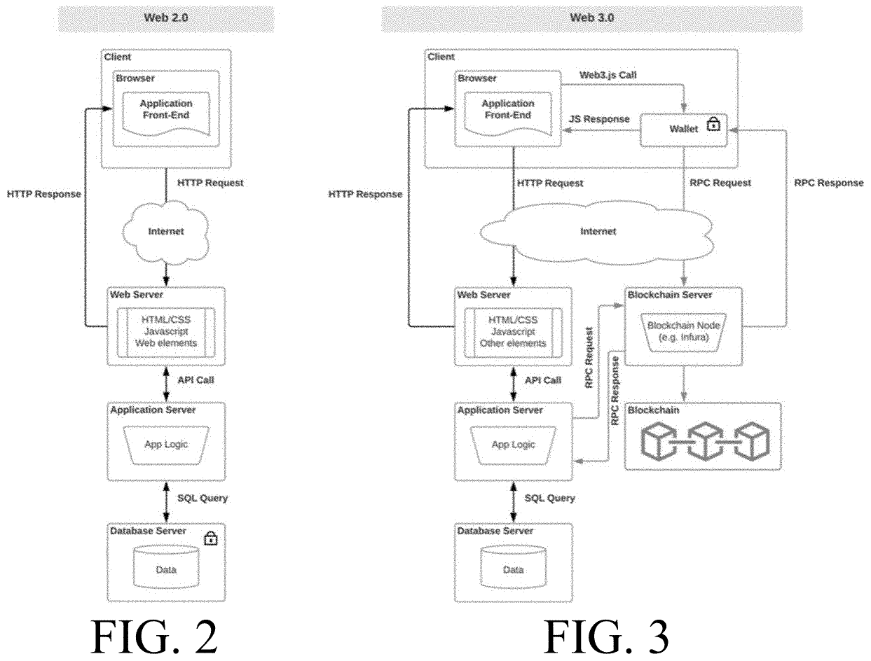

FIG. 2 is a block diagram of an example web 2.0 architecture which may be used for one or more implementations described herein. In particular, FIG. 2 shows a client having a browser and an application front-end, where the client is connected via a network (e.g., the Internet) to a web server hosting an application including one or more technologies such as HTML/CSS, Javascript, and web elements. The web server is coupled to an application server providing application logic (e.g., via API calls). The application server is coupled to a database server storing data accessible via a query (e.g., an SQL query).

FIG. 3 is a block diagram of an example web 3.0 architecture which may be used for one or more implementations described herein. The architecture of FIG. 3 includes the elements of FIG. 2 along with a blockchain server including a blockchain node, where the blockchain server is coupled to a blockchain and a wallet. The wallet is coupled to the browser/application front end of the client (e.g., via an RPC request/response mechanism).

The systems of FIG. 2 and FIG. 3 can be used to provide the contract lifecycle management functions discussed herein.

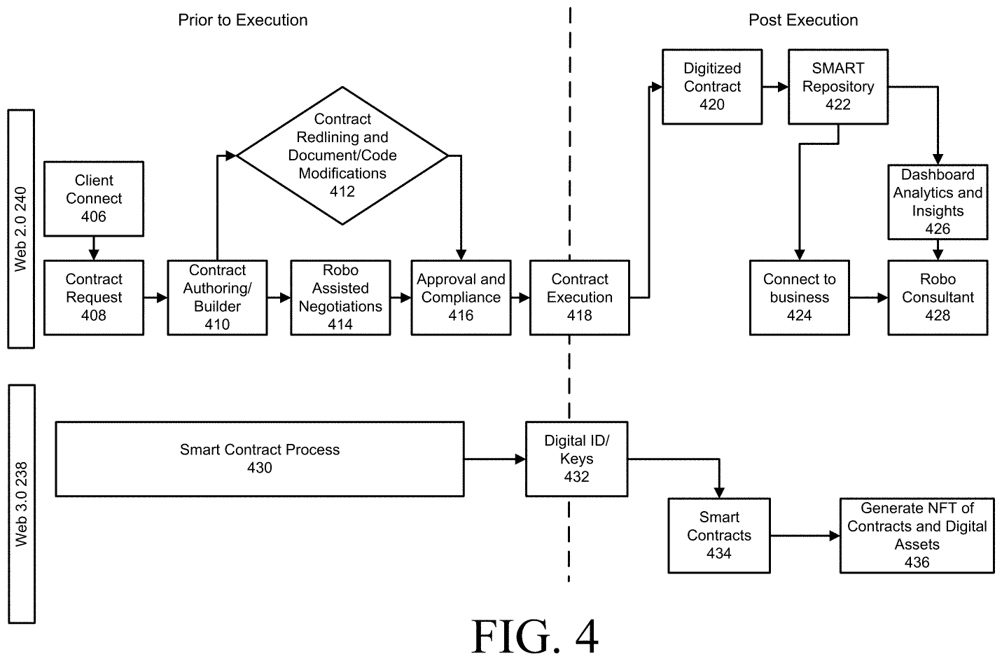

FIG. 4 is a diagram showing a contract lifecycle management process in accordance with some implementations. FIG. 4 shows processes accomplished using web 2.0 technologies (horizontal section 240) and web 3.0 technologies (horizontal section 238), which can be implemented using the architectures of FIGS. 2 and 3, respectively. FIG. 4 also shows two phases: prior to execution (e.g., left of dashed vertical line) and post execution (to the right of the dashed vertical line).

At 406, a client connect step provides a dashboard including analytics and insights. Contract impact assessment begins with visibility and connection to the business.

In an example Web 2.0 implementation, client connect 406 includes: aggregating business data for visibility in dashboards; connecting multiple data sources (e.g., one or more of ERP, CRM, current contracts, taxonomy, and third-party information); capturing gaps, expirations, and important/critical information relative to the contract; and alerting (e.g., generating a notification) of critical information and actions requiring attention.

In an example Web 3.0 implementation, client connect 406 can include one or more of: dashboard visibility of current smart contracts and status, compliance/non-compliance, tracking digital assets/NFTs, capturing errors, displaying critical information, and actions requiring attention, and generating alerts for critical information, compliance and actions requiring attention.

In an example, assume Supplier 222 shows on client connect dashboard to have $10M of spend annually but no active contract is in place to govern the relationship. A gap is identified in client connect dashboard for action to create a contract.

At 408, a contract request is received, where the contract request is triggered automatically or manually. In an example Web 2.0 implementation, 408 can include: an easy and intuitive request process for a user including AI assistance in request process by utilizing information within AI access (e.g., a data feed from client connect or previous contract information); an AI configured to scan input document to build and auto-populate a contract request using information known about user and one or more third parties; accepting third party paper for contract processing; providing an option to begin traditional contract; generating digital contracts that are human and computed coded; and/or generating a smart contract from one or more pre-built (customizable) templates; and providing end to end process workflows defined by client for automation.

In an example Web 3.0 implementation, 408 can include: an option to begin traditional contract; smart contract; or both from pre-built (customizable) templates; providing an easy and intuitive request process for user with AI Assistance in request process by utilizing information within AI access (e.g. data feed from client connect or previous contract information); triggering a smart contract by a user; providing a trigger from traditional contract to create a smart contract; triggering a contract request from smart contract or AI (with optional human validation as required by company); and providing end to end workflows defined by client for automation (may be executed by smart contracts).

Continuing with the Supplier 222 example, a Contract Request 408 is triggered from client connect dashboard for Supplier 222. In some implementations, AI assists with making the request process seamless by helping to populate information about Supplier 222. User selects the option to create a digital Master Services Agreement (MSA) and smart contract template for Scopes of Work (SOW[s]) for Supplier 222. The smart contract SOW Template can be used after the MSA is executed. Further, the process can include triggering the smart contract SOW, which informs the system that the relationship will be managed and executed in both Web 2.0 and Web 3.0.

At 410, a contract authoring/builder process is performed. An example Web 2.0 implementation can include generating a contract draft from templates and clause libraries, where the contract can include a traditional (natural language contract) or a digital contract (natural language and coded language contracts). Providing an ability to modify, add contract variables, and customize contract for specific needs before sending out. Triggering a smart contract builder in parallel (if applicable) and utilizing a contract playbook available to use to customize contract. Providing an ability to ingest third party paper and AI assists in identifying clauses required based on company playbooks and training (for human validation).

An example Web 3.0 implementation includes generating a digital (coded) contract and/or smart contract code from request info, templates, and clause libraries that can be modified/customized for specific needs. Some implementations can include providing a general scope: stand-alone contracts, scopes of works, low complexity, and routine type agreements. Further, electronic contract playbooks available to use to customize contract based on company practices. Some implementations can include an ability to ingest third party paper and an AI that assists in identifying code/clauses required based on company playbooks and training (for human validation).

Continuing with the Supplier 222 example, at 410, a digital MSA template is created for Supplier 222 (e.g., including natural language and coded contract views) and a SOW in the form of a smart contract. A user can utilize available contract playbooks to customize contract and digital and smart contract code prior to sending for counterparty review. The user can trigger the system to invite/send a digital MSA and smart contract SOW for counterparty review.

At 412, document redlining, and contract document/code modifications are made in conjunction with robo-assisted negotiations 414. For example, in some Web 2.0/Web 3.0 implementations, a collaborative redlining tool functionality is provided within the system and electronic contract playbooks available for use. In some implementations, redlining of coded contracts includes variables changed automatically, but non-variable changes will be presented for review and approval by both parties once natural language contract redlining is completed. Alternatively, contract redlining functionality available in tool with plug-ins with outlook and work. Some implementations can utilize playbooks; analyze for compliance; and provide robo (AI/ML) assisted contract review/negotiations (robo functionality may be enabled/disabled based on user and company preferences). In some implementations, robo assisted review will be enabled after high levels of training or highly supervised training per client request. Coded contracts can be changed based upon final agreements to terms.

In an example of functionality, in 412/414 after review by counterparty, a user can begin negotiation/redlining digital MSA within the tool to capture collaboration and agreement. During review, an AI/ML model can propose company playbook language to pushback on changes and suggestions on comments. For example, an AI can recommend pushing back on reduced payment terms and makes suggestion for comment that the reduced payment term is against their finance policy and cannot be accepted. In this example, the MSA incurs a variable change for the payment term, and automatically changes variable in coded MSA contract. No changes are made to smart contract template code based on the redlining.

At 416, approval and compliance reviews are performed, including generating a compliance report. In an example Web 2.0 implementation, contract compliance ratings & reports made available for users, approvers, and signatories, where approval and compliance flows are based on company defined workflows. Some implementations can include no code/low code workflows.

In an example Web 3.0 implementation, digital contract and smart contract generation follows company defined approval/compliance and can utilize utilizes private/public keys/oracles/digital ids/etc. to approve contracts. In some implementations, standard templates for workflows are available for customization.

Continuing with the Supplier 222 example, once company representatives and Supplier 222 agree on contract terms, the digital MSA goes through automated defined workflows for approvals of digital MSA's@$10M based on company matrix and AI prepares compliance report for risks and opportunities of MSA. A customized smart contract based on new SOW goes through company defined workflow immediately after MSA.

At 418, a digital signature process is performed. For example, the digital signature process can include Web 2.0 features such as signature flows based on company defined workflows, digital signatures/server information and option for integration with third parties, and a traditional signature tracker. Some implementations can include a system that tracks status of signatures with notifications/reminders.

An example Web 3.0 can include a smart contract that follows company defined signature flow set (may be executed in smart contract flow) and utilizes digital ids/keys to execute contracts. Some implementations can include a system that tracks status of signatures with notifications/reminders.

Continuing with the example, a digital MSA directed to appropriate parties for signature per contract information and workflows is generated and sent to the respective parties, which can execute it via digital signature and digital IDs. Some implementations can include a smart contract SOW that is directed to the appropriate parties digital ID for approval/execution and to go on-chain for execution.

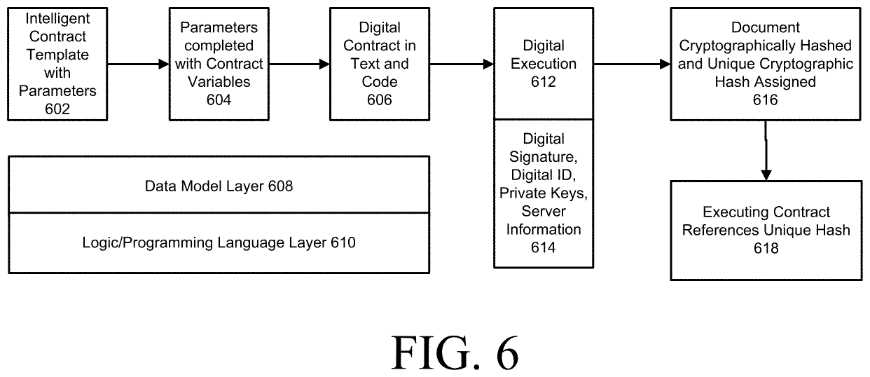

At 420, a digitized contract process is performed. The process is described here and also in connection with FIG. 6 below. In a Web 2.0/Web 3.0 implementation, the system contracts cryptographically hashed for security and encryption and generates a unique cryptographic hash assigned to document(s). The system also generates a coded contract able to be used in other systems/Web 3.0/blockchain etc. In some implementations, unique assigned keys can unlock natural language and coded contracts and a unique cryptograph hash number can be used to reference document in other areas.

Continuing with the example of functionality, the digital MSA for 222 Enterprises is cryptographically hashed and a unique cryptographic hash number is assigned to the MSA. A cryptographic hash number of MSA is included in smart contract SOW for execution and reference.

At 422, a contract repository process with intelligent document processing is performed. An example Web 2.0 implementation of the intelligent document processing can include performing OCR (searchability) on structured data, IDP (Intelligent Document Processing) on unstructured data, generating a document hierarchy, generating alerts, alerts, and extracting key clauses and data for connect to business function. Some implementations can include a stage of training/retraining AI on missed classification, which can be important to continuous customer learning loop.

In an example Web 3.0 implementation, NFT contracts are transformed into digital assets, an audit trail of smart contracts is maintained. In some implementations, key clauses and data are extracted for connect to business function. Some implementations can include a stage of training/retraining AI on missed classification, which can be important to continuous customer learning loop.

Continuing with the example functionality, the MSA for Supplier 222 can be stored in the smart repository with a cryptographic hash number for reference, and then the intelligent document processing (IDP) begins the AI extraction of terms and contract metadata, and a user can optionally validate IDP function by AI.

In some implementations, key data can also be extracted from smart contract to utilize on dashboards and for off-chain purposes/data/validation.

In some implementations, AI features/functionality can include:
AI model built to initially recognize a number (e.g., 100) of clause types and will grow over time with increased utilization and training;
AI model can be retrained within repository data to adapt over time;
AI model built with complex supervised/unsupervised model;
   Data of Breakdown->Clause->Sub-Clause->Term->Data Point;

At 424, a connect to business process is performed. An example Web 2.0 implementation can include provision for a user to connect certain contract terms by taxonomy data/revenue/spend. In some implementations, automation pulls existing items from ERP and an AI can attempt automatic connection of certain contract terms to business items. in some implementations, human validation and retraining of a ml model can be used for quality assurance and continuous learning. Some implementations can include inventory and asset assignment management functionality for traceability to contract.

An example Web 3.0 implementation can permit a User to Connect Smart Contracts By Taxonomy Data/Revenue/Spend/On-Chain Data. Some implementations can include automation to extract existing items from ERP/Blockchain data and an AI that attempts connection of certain contract terms to business items.

Some implementations can include human validation and ML model retraining for quality assurance and continuous learning. Some implementations can include inventory and digital asset assignment management functionality for traceability to contract.

Continuing with the example, a user utilizes the connect to business feature to create and validate AI connections of business items to certain contract terms. Once completed or validated, the solution now can provide visibility and correlation of the MSA contract terms to business items and transactions of Supplier 222 (e.g., for quality, compliance, validation, tracking, etc.)

At 426, a dashboard analytics and insight process is performed. An example Web 2.0 implementation can go beyond data visibility and focuses on actionable insights. some implementations can include contract driven buying guides, suggest contract consolidation opportunities, identify contract leakage opportunities, and include market data.

An example Web 3.0 implementation can include dashboard visibility of smart contracts and status displaying one or more of alerts, compliance/non-compliance, digital assets/NFTs. Additionally, the implementation can capture errors, critical information, & actions requiring attention.

Continuing with the example, Data from MSA from Supplier 222 Brings Insights to enhanced dashboards to show agreement status, contract terms, metadata, compliance, along with what items are purchased by spend and under contract. Further, the smart contract SOW is also visible on dashboard to monitor status and execution.

At 428, a robo-consultant process is performed. An example Web 2.0 implementation can include displaying AI/ML generated highlights insights, opportunities, and risks. Some implementations can include an interface to ask the AI/ML model questions. Some implementations can include an AI algorithm/ML model trained on basic analyst work.

An example Web 3.0 implementation can include AI/ML generated highlights insights, opportunities, and risks. Some implementations can include an ability to Ask the AI/ML model questions. Some implementations can include an AI Algorithm trained on basic analyst work.

Continuing with the Supplier 222 example, AI highlights to business that the MSA with Supplier 222 has a financial commitment of $15M per year. As of Q3, spend is at $7.5M and attention is needed to determine actions required to mitigate risk (for example, renegotiate with supplier, confirm additional $7.5M before end of year, etc.)

In the Web 2.0 architecture 438, the smart contracts process 430 can span multiple steps and can include one or more of contract initiation, contract templates, workflows, collaboration and communication, and end-to-end workflows built for client and customized needs. Web 2.0 features can also provide digital ID and Keys 432 (see also, FIG. 6 and corresponding description). Smart Contracts 434 can link directly to a digitized contract with a cryptographic hash as described herein. Finally, at 436 an NFT can be created from the contracts or other digital assets.

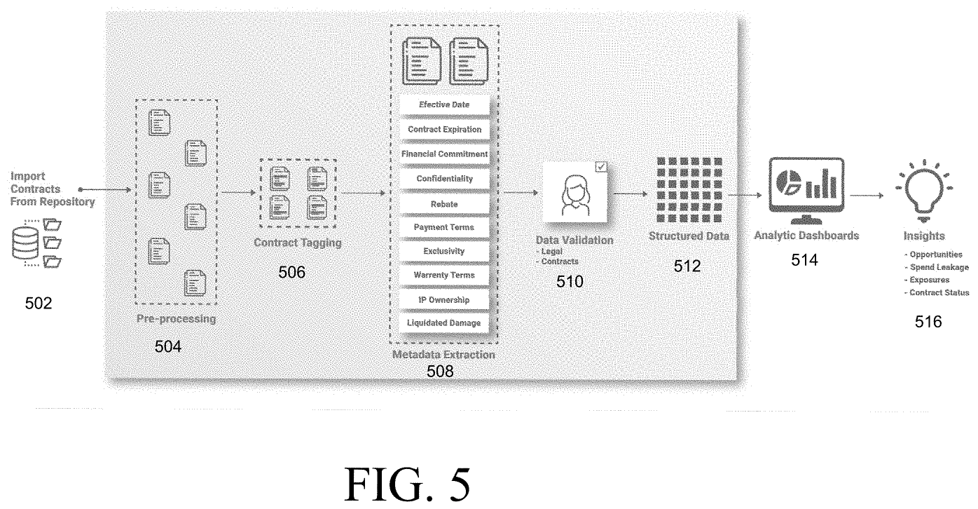

FIG. 5 is a diagram showing details of computerized automatic document processing in accordance with some implementations. Processing begins at 502, where digital contracts are imported from the repository. At 504, the imported contracts undergo preprocessing to identify data items in the contracts. At 506, the contract(s) are tagged (e.g., using a ML model or AI to tag aspects of the contracts. At 508, contract metadata is extracted. The metadata can include one or more effective date, contract expiration, financial commitment, confidentiality, rebate, payment terms, exclusivity, warranty terms, IP ownership, and/or liquidated damages.

At 510, the data is validated (e.g., manually or automatically) for legal and contracts aspects. At 512, the extracted data is placed into a structured data framework. At 514, the structured data can be provided to an analytics dashboard. At 516, insights can be suggested by the ML model or AI based on the structured data or can be gleaned by a user through the analytics dashboard.

FIG. 6 is a diagram showing details of digital contract processing in accordance with some implementations. As shown in FIG. 6, an intelligent contract template with one or more parameters 602 is combined with parameters completed with contract variables 604. The combination of 602 and 604 is controlled by a data model layer 608 and logic/programming language layer 610 to programmatically generate a digital contract in text (e.g., human readable contract language) and computer code (e.g., structured data representation of contract language) 606. The data model layer 608 and the logic/programming language layer 610 can be used to translate between the natural language version of the contract and the computer code counterpart (or structured code).

The digital contract can be modified or redlined—via modifying the natural language version , the parameters or the code version. Once accepted by all parties, the digital contract can be executed 612 using one or more of a digital signature, a digital ID, private keys, and server information 614. The contract document and any supporting documents can be cryptographically hashed 616 and a unique cryptographic hash value generated and assigned to the contract. Executing the contract can include referencing the unique cryptographic has value 618.

FIG. 7 is a block diagram of an example device 700 which may be used to implement one or more features described herein, such as full life cycle contract formation, management, and monitoring functions. In one example, device 700 may be used to implement a client device, e.g., any of client devices 120-126 shown in FIG. 1. Alternatively, device 700 can implement a server device, e.g., server device 104, etc. In some implementations, device 700 may be used to implement a client device, a server device, or a combination of the above. Device 700 can be any suitable computer system, server, or other electronic or hardware device as described above.

One or more methods described herein (e.g., FIGS. 4-6 and/or full life cycle contract formation, management, and monitoring functions) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 700 includes a processor 702, a memory 704, and I/O interface 706. Processor 702 can be one or more processors and/or processing circuits to execute program code and control basic operations of the device 700. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 702 may include one or more co-processors that implement neural-network processing. In some implementations, processor 702 may be a processor that processes data to produce probabilistic output, e.g., the output produced by processor 702 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, machine-learning application 730, full life cycle contract formation, management, and monitoring functions application 712, and application data 714. Other applications may include applications such as a data display engine, web hosting engine, image display engine, notification engine, social networking engine, etc. In some implementations, the machine-learning application 730 and full life cycle contract formation, management, and monitoring functions application 712 can each include instructions that enable processor 702 to perform functions described herein, e.g., some or all of the methods of FIGS. 4-6.

The machine-learning application 730 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a full life cycle contract formation, management, and monitoring functions application 712 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 730 may utilize Bayesian classifiers, support vector machines, neural networks, or other learning techniques. In some implementations, machine-learning application 730 may include a trained model 734, an inference engine 736, and data 732. In some implementations, data 732 may include training data, e.g., data used to generate trained model 734. For example, training data may include any type of data suitable for training a model for full life cycle contract formation, management, and monitoring tasks, such as documents, document images, labels, thresholds, etc. associated with full life cycle contract formation, management, and monitoring functions described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 734, training data may include such user data. In implementations where users permit use of their respective user data, data 732 may include permitted data.

In some implementations, data 732 may include collected data such as contract documents, document images, contract monitoring data, etc. In some implementations, training data may include synthetic data generated for the purpose of training, such as data that is not based on user input or activity in the context that is being trained, e.g., data generated from simulated conversations, computer-generated images, etc. In some implementations, machine-learning application 730 excludes data 732. For example, in these implementations, the trained model 734 may be generated, e.g., on a different device, and be provided as part of machine-learning application 730. In various implementations, the trained model 734 may be provided as a data file that includes a model structure or form, and associated weights. Inference engine 736 may read the data file for trained model 734 and implement a neural network with node connectivity, layers, and weights based on the model structure or form specified in trained model 734.

Machine-learning application 730 also includes one or more trained models 734. In some implementations, the trained model 734 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 732 or application data 714. Such data can include, for example, images, e.g., when the trained model is used for full life cycle contract formation, management, and monitoring functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image contains one or more contract terms, etc. depending on the specific trained model. In some implementations, model form or structure also specifies a number and/or type of nodes in each layer.

In different implementations, the trained model 734 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph of a contract, frames in a video, speech or other audio, etc.

In some implementations, trained model 734 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 732, to produce a result.

For example, training may include applying supervised learning techniques. In supervised learning, the training data can include a plurality of inputs (e.g., a set of document images, contract language, contract execution results, etc.) and a corresponding expected output for each input (e.g., one or more labels for each image representing aspects of a contract such as recommended contract language for services or products). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify contract terms that are associated with images and/or select thresholds for contract formation or monitoring task recommendation.

In another example, a model trained using unsupervised learning may cluster words based on the use of the words in data sources. In some implementations, unsupervised learning may be used to produce knowledge representations, e.g., that may be used by machine-learning application 730. In various implementations, a trained model includes a set of weights, or embeddings, corresponding to the model structure. In implementations where data 732 is omitted, machine-learning application 730 may include trained model 734 that is based on prior training, e.g., by a developer of the machine-learning application 730, by a third-party, etc. In some implementations, trained model 734 may include a set of weights that are fixed, e.g., downloaded from a server that provides the weights.

Machine-learning application 730 also includes an inference engine 736. Inference engine 736 is configured to apply the trained model 734 to data, such as application data 714, to provide an inference. In some implementations, inference engine 736 may include software code to be executed by processor 702. In some implementations, inference engine 436 may specify circuit configuration (e.g., for a programmable processor, for a field programmable gate array (FPGA), etc.) enabling processor 702 to apply the trained model. In some implementations, inference engine 736 may include software instructions, hardware instructions, or a combination. In some implementations, inference engine 736 may offer an application programming interface (API) that can be used by operating system 708 and/or full life cycle contract formation, management, and monitoring functions application 712 to invoke inference engine 736, e.g., to apply trained model 734 to application data 714 to generate an inference.

Machine-learning application 730 may provide several technical advantages. For example, when trained model 734 is generated based on unsupervised learning, trained model 734 can be applied by inference engine 736 to produce knowledge representations (e.g., numeric representations) from input data, e.g., application data 714. For example, a model trained for full life cycle contract formation, management, and monitoring tasks may produce predictions and confidences for given input information about a contract being proposed or planned. A model trained for suggesting full life cycle contract formation, management, and monitoring tasks may produce a suggestion for one or more phases of a contract formation or lifecycle based on input images, contract requirements, or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 736.

In some implementations, knowledge representations generated by machine-learning application 730 may be provided to a different device that conducts further processing, e.g., over a network. In such implementations, providing the knowledge representations rather than the images may provide a technical benefit, e.g., enable faster data transmission with reduced cost. In another example, a model trained for full life cycle contract formation, management, and monitoring functions may produce a contract formation or monitoring signal for one or more contract document images being processed by the model.

In some implementations, machine-learning application 730 may be implemented in an offline manner. In these implementations, trained model 734 may be generated in a first stage and provided as part of machine-learning application 730. In some implementations, machine-learning application 730 may be implemented in an online manner. For example, in such implementations, an application that invokes machine-learning application 730 (e.g., operating system 708, one or more of full life cycle contract formation, management, and monitoring functions application 712 or other applications) may utilize an inference produced by machine-learning application 730, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 734, e.g., to update embeddings for trained model 734.

In some implementations, machine-learning application 730 may be implemented in a manner that can adapt to particular configuration of device 700 on which the machine-learning application 730 is executed. For example, machine-learning application 730 may determine a computational graph that utilizes available computational resources, e.g., processor 702. For example, if machine-learning application 730 is implemented as a distributed application on multiple devices, machine-learning application 730 may determine computations to be carried out on individual devices in a manner that optimizes computation. In another example, machine-learning application 730 may determine that processor 702 includes a GPU with a particular number of GPU cores (e.g., 1000) and implement the inference engine accordingly (e.g., as 1000 individual processes or threads).

In some implementations, machine-learning application 730 may implement an ensemble of trained models. For example, trained model 734 may include a plurality of trained models that are each applicable to same input data. In these implementations, machine-learning application 730 may choose a particular trained model, e.g., based on available computational resources, success rate with prior inferences, etc. In some implementations, machine-learning application 730 may execute inference engine 736 such that a plurality of trained models is applied. In these implementations, machine-learning application 730 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 708 or one or more other applications, e.g., full life cycle contract formation, management, and monitoring functions application 712.

In different implementations, machine-learning application 730 can produce different types of outputs. For example, machine-learning application 730 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 730 may produce an output video with a particular effect applied, e.g., rendered in a comic-book or particular artist's style, when trained model 734 is trained using training data from the comic book or particular artist, etc. In some implementations, machine-learning application 730 may produce an output based on a format specified by an invoking application, e.g., operating system 708 or one or more applications, e.g., full life cycle contract formation, management, and monitoring functions application 712. In some implementations, an invoking application may be another machine-learning application. For example, such configurations may be used in generative adversarial networks, where an invoking machine-learning application is trained using output from machine-learning application 730 and vice-versa.

Any of software in memory 704 can alternatively be stored on any other suitable storage location or computer-readable medium. In addition, memory 704 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. Interfaced devices can be included as part of the device 700 or can be separate and communicate with the device 700. For example, network communication devices, storage devices (e.g., memory and/or database 106), and input/output devices can communicate via I/O interface 706. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 706 can include one or more display devices 720 and one or more data stores 738 (as discussed above). The display devices 720 that can be used to display content, e.g., a user interface of an output application as described herein. Display device 720 can be connected to device 700 via local connections (e.g., display bus) and/or via networked connections and can be any suitable display device. Display device 720 can include any suitable display device such as an LCD, LED, or plasma display screen, CRT, television, monitor, touchscreen, 3-D display screen, or other visual display device. For example, display device 720 can be a flat display screen provided on a mobile device, multiple display screens provided in a goggles or headset device, or a monitor screen for a computer device.

The I/O interface 706 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 7 shows one block for each of processor 702, memory 704, I/O interface 706, and software blocks 708, 712, and 730. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While some components are described as performing blocks and operations as described in some implementations herein, any suitable component or combination of components of environment 100, device 700, similar systems, or any suitable processor or processors associated with such a system, may perform the blocks and operations described.

In some implementations, logistic regression can be used for personalization (e.g., full life cycle contract formation, management, and monitoring function suggestions based on a user's pattern of contract activity). In some implementations, the prediction model can be handcrafted including hand selected contract term labels and thresholds. The mapping (or calibration) from ICA space to a predicted precision within the contract formation and monitoring space can be performed using a piecewise linear model.

In some implementations, the full life cycle contract formation, management, and monitoring functions system could include a machine-learning model (as described herein) for tuning the system (e.g., selecting contract image labels and corresponding thresholds) to potentially provide improved accuracy. Inputs to the machine learning model can include ICA labels, an image descriptor vector that describes appearance and includes semantic information about a contract. Example machine-learning model input can include labels for a simple implementation and can be augmented with descriptor vector features for a more advanced implementation. Output of the machine-learning module can include a prediction of suggested contract negotiations terms, etc.

One or more methods described herein (e.g., the method of FIGS. 4-6) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A method comprising:
receiving a contract request;
generating a draft contract based on a combination of an intelligent contract and one or more parameters, wherein the draft contract includes a natural language version and a structured code counterpart, and wherein the combination is further based on a data model layer and a logic layer;
receiving one or more contract modifications;
applying the one or more contract modifications to the natural language version and the structured code counterpart of the draft contract to generate a redlined draft contract;
receiving approval of the redlined draft contract;
generating a cryptographic hash value based on the redlined draft contract, a public key, and a private key;
digitally executing the redlined draft contract using a digital signature and the private key; and
outputting an executed contract that includes a reference to the cryptographic hash value.
